(19) United States
(12) Patent Application Publication
(10) Pub. No.: US 2013/0262258 A1
(43) Pub. Date: Oct. 3, 2013

(54) SYSTEMS AND METHODS FOR RANKING AND FILTERING PROFESSIONALS BASED ON USER INPUT AND ACTIVITY AND INTERFACING WITH PROFESSIONALS WITHIN AN ONLINE COMMUNITY

(71) Applicant: Kathleen Jennings, La Jolla, CA (US)

(72) Inventor: Kathleen Jennings, La Jolla, CA (US)

(21) Appl. No.: 13/853,984

(22) Filed: Mar. 29, 2013

Related U.S. Application Data
(60) Provisional application No. 61/618,590, filed on Mar. 30, 2012.
(60) Provisional application No. 61/618,595, filed on Mar. 30, 2012.
(60) Provisional application No. 61/618,597, filed on Mar. 30, 2012.

(51) Int. Cl. G06Q 30/06

(52) U.S. Cl. CPC G06Q 30/0601
USPC 705/26.4

(57) ABSTRACT

Systems and methods for selecting a tax professional. In an embodiment, one or more search criteria are received from a user. In addition, rating information is generated and associated with each of a plurality of professional users. The plurality of professional users may be filtered based on the one or more search criteria and the rating information to identify a subset of one or more professional users. The identified subset of one or more professional users is then provided to the user.

### PRIORITY

This application claims priority to U.S. Provisional Patent App. No. 61/618,590, filed on Mar. 30, 2012, and titled “Systems and Methods for Ranking and Filtering Professionals Based on User Input and Activity,” U.S. Provisional Patent App. No. 61/618,595, filed on Mar. 30, 2012, and titled “Systems and Methods for Ranking Professionals Based on User Input and Activity,” and U.S. Provisional Patent App. No. 61/618,597, filed on Mar. 30, 2012, and titled “Systems and Methods for Interfacing with a Professional within an Online Community,” the entireties of all of which are hereby incorporated herein by reference.

### BACKGROUND

1. Field of the Invention

The embodiments described herein are generally directed to identifying a professional based on user-specified criteria, and, more particularly, to identifying a tax professional using an online system through various search and filtering criteria.

2. Description of the Related Art

Conventionally, locating a professional, such as a tax professional, is difficult. Historically, most individuals identify a tax professional by asking someone they know for a referral. However, this is not necessarily an efficient or effective method of finding a professional. Different individuals may be differently situated and have different needs, preferences, desires, etc. Accordingly, a tax professional that is appropriate for one individual may not be appropriate for the individual to whom they are being recommended or referred.

For example, a first individual may be employed with a modest salary, whereas a second individual may be a small business owner with many investments. A tax professional that is best suited for the first individual may not be as well suited for the second individual. Moreover, the two individuals may have vastly different personalities and preferences, which influence the type of professional with which they would be comfortable. Of course, businesses and organizations can also have entirely different needs.

What has been lacking is a system or method that allows two very different individuals to each find a professional that suites their individual tastes and needs. Moreover, most professionals (e.g., tax professionals) are either too busy, unwilling, or otherwise unable to effectively market themselves or establish a brand around the areas and expertise that they offer.

### SUMMARY

Accordingly, systems and methods are disclosed for ranking and filtering professionals based on user input and activity.

In an embodiment, a method for selecting a tax professional is disclosed. The method comprises, by at least one hardware processor executing a web application: receiving one or more search criteria from a user; generating rating information associated with each of a plurality of professional users; filtering the plurality of professional users, based on the one or more search criteria and the rating information, to identify a subset of one or more professional users; and providing the identified subset of one or more professional users to the user.

In an additional embodiment, a system for selecting a tax professional is disclosed. The system comprises: at least one hardware processor; and at least one executable software module that, when executed by the at least one hardware processor, receives one or more search criteria from a user, generates rating information associated with each of a plurality of professional users, filters the plurality of professional users, based on the one or more search criteria and the rating information, to identify a subset of one or more professional users, and provides the identified subset of one or more professional users to the user.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a system for ranking and filtering professionals, according to an embodiment;

FIG. 2 illustrates an example home page, according to an embodiment;

FIG. 3 illustrates an example questions list, according to an embodiment;

FIG. 4 illustrates an example question details interface, according to an embodiment;

FIG. 5 illustrates an example question submission interface, according to an embodiment;

FIG. 6 illustrates an example events list interface, according to an embodiment;

FIG. 7 illustrates an example event details interface, according to an embodiment;

FIG. 8 illustrates a list of blog entries, according to an embodiment;

FIGS. 9A-9D illustrate example user interfaces for a registration process, according to an embodiment;

FIG. 10 illustrates a professional member profile interface, according to an embodiment;

FIG. 11 illustrates a pop-up for requesting access to a professional member's virtual boardroom, according to an embodiment; and

FIG. 12 illustrates a processing system on which one or more of the processes described herein may be executed, according to an embodiment.

### DETAILED DESCRIPTION

In embodiments, systems and methods are described for ranking and filtering professionals. This ranking and/or filtering may be based on user input and/or activity.

System Overview

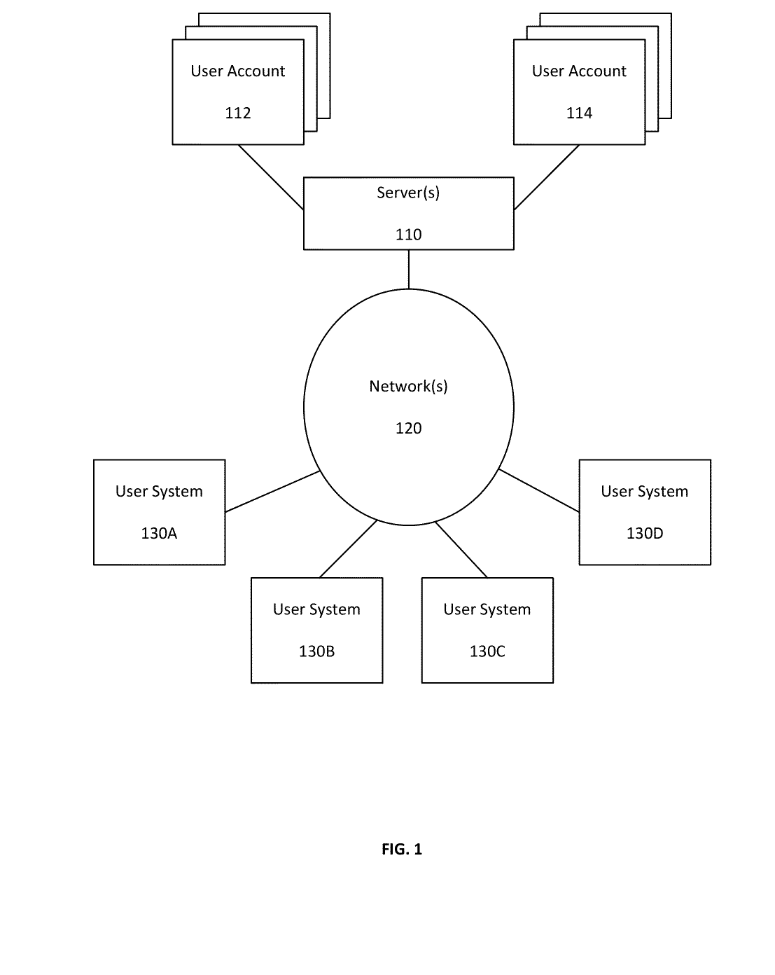

FIG. 1 illustrates an example system for ranking and filtering professionals, according to an embodiment. The system may comprise a server platform 110 comprising a set of one or more servers which host and/or execute one or more of the various functions, processes, and/or software modules described herein. In addition, server(s) 110 are communicatively connected to one or more user systems 130 via one or more network(s) 120. Network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and the like, as well as proprietary protocols. In an embodiment, server(s) 110 may not be dedicated servers, and may instead be cloud instances, which utilize shared resources of one or more servers. Furthermore, while server(s) 110 are illustrated as being connected to various systems through a single set of network(s) 120, it should be understood that the server(s) 110 may be connected to the various systems via different sets of one or more networks. For example, server(s) 110 may be connected to a subset of user systems 130 via the Internet, but may be connected to one or more other user systems 130 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, Automated Teller Machines, and the like. In addition, while only a few user systems 130 and one set of server(s) 110 are illustrated, it should be understood that the network may comprise any number of user systems and sets of server(s).

Server(s) 110 may comprise web servers which host one or more websites or web services. In embodiments in which a website is provided, the website may comprise one or more user interfaces, including, for example, webpages generated in HyperText Markup Language (HTML) or other language. Server(s) 110 transmit or serve these user interfaces in response to requests from user system(s) 130. In some embodiments, these user interfaces may be served in the form of a wizard, in which case two or more user interfaces may be served in a sequential manner, and one or more of the sequential user interfaces may depend on an interaction of the user or user system with one or more preceding user interfaces. The requests to server(s) 110 and the responses from server(s) 110, including the user interfaces, may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (not shown) that are locally and/or remotely accessible to the server(s) 110. Server(s) 110 may also respond to other requests from the user system(s) 130.

Server(s) 110 may further comprise, be communicatively coupled with, or otherwise have access to one or more database(s). For example, server(s) 110 may comprise one or more database servers which manage one or more databases. A user system 130 or application executing on server(s) 110 may submit data (e.g., user data, form data, etc.) to be stored in the database(s), and/or request access to data stored in such database(s). Any suitable database may be utilized, including without limitation MySQL, Oracle, IBM, Microsoft SQL, Sybase, Access, and the like, including cloud-based database instances. Data may be sent to the server(s) 110, for instance, using the well-known POST request supported by HTTP, via FTP, etc. This data, as well as other requests, may be handled, for example, by server-side web technology, such as a servlet or other software module, executed by the server(s) 110.

In embodiments in which a web service is provided, server(s) 110 may receive requests from user system(s) 130, and provide responses in eXtensible Markup Language (XML) and/or any other suitable or desired format. In such embodiments, server(s) 110 may provide an application programming interface (API) which defines the manner in which user system(s) 130 may interact with the web service. Thus, user system(s) 130, which may themselves be servers, can define their own user interfaces, and rely on the web service to implement the backend processes, functionality, storage, etc., described herein. For example, in such an embodiment, a client application executing on one or more user system(s) 130 may interact with a server application executing on server(s) 110 to execute one or more or a portion of one or more of the various functions, processes, and/or software modules described herein. The client application may be “thin,” in which case processing is primarily carried out server-side by server(s) 110. A simple example of a thin client application is a browser application, which simply requests, receives, and renders web pages at user system(s) 130, while server(s) 110 are responsible for generating the web pages and managing database functions. Alternatively, the client application may be “thick,” in which case processing is primarily carried out client-side by user system(s) 130. It should be understood that the client application may perform an amount of processing, relative to server(s) 110, at any point along this spectrum between “thin” and “thick,” depending on the design goals of the particular implementation. In any case, the application, which may wholly reside on either the server(s) or user system(s) or be distributed between the server(s) or user system(s), can comprise one or more executable software modules that implement one or more of the processes or functions of the application(s) described herein.

Web Application Overview

In an embodiment, server platform 110 comprises a web application which provides one or more user interfaces and which enable professionals and potential clients to interact with each other. The web application may comprise one or more user interfaces which allow professionals, such as tax professionals, to establish a user account 112 (e.g., username/email and password) which provides a professional with access to the platform 110, and/or a user profile 114 which comprises information about the professional (e.g., name, contact information, credentials, qualifications, etc.). In addition, the web application may comprise one or more user interfaces which allow other users (e.g., seeking a professional) to establish a user account 112 (e.g., username/email and password) which provides a user with access to the platform 110 and/or or a user profile 114 which comprises information about the user (e.g., name, contact information, etc.). Users can access the platform to interact with and select professionals. While the embodiments disclosed herein will primarily be described in relation to tax professionals, it should be understood that the disclosed embodiments may be adapted for any type of professional.

In an embodiment, the web application comprises a website, and the user interfaces of the web application comprise web pages which are consistent throughout the web application. For instance, the web application may comprise a web server that serves dynamic and/or static web pages in response to requests from user system(s) 130. Each web page may comprise a consistent sign-up input and login input (e.g., if the user has not registered or logged in to the web application), logout input (e.g., if the user has registered and logged in to the web application), search input, header and footer, and/or feedback bar. The sign-up input allows a user to register with the web application. The login input allows a registered user to log in to the web application (i.e., access functionality of the web application that is unavailable to unregistered users). The logout input allows a user who has logged in to the web application to sign out of his or her account.

Users, including professionals and those seeking a professional, can access the web application using a user system 130, which may comprise any one or more of a variety of computing devices capable of communications over network(s) 120 (e.g., comprising the Internet). In an embodiment, users may comprise visitors, free members, and tax professional members. A visitor is someone who is visiting the web application, but who has not registered with the web application, or who has registered but has not logged in to the web application. A free member is someone who has registered with the web application for the purposes of finding a professional or asking a question. In an embodiment, there is no cost to a free member to use the web application. A professional member is a professional (e.g., tax professional) that has registered with the web application to promote his or her expertise (e.g., tax expertise) in the web application's interactive directory of professionals that is available to visitors, free members, and other tax professional members (e.g., searching for expertise outside of their own area of expertise). In an embodiment, a professional member must purchase his or her membership (e.g., as a subscription, such as a monthly subscription).

1. Header

Each user interface may comprise a header with inputs (e.g., hyperlinks) for accessing one or more other user interfaces. In an embodiment, the header may comprise a different color scheme depending on the type of member. For example, a visitor and a non-professional member (e.g., a free member) may see a first header (e.g., blue-themed header), whereas a professional member may see a second header (e.g., green-themed header). The first header may comprise hyperlinks for returning to a home page or landing page of the web application, accessing a user interface for finding a tax professional, asking a tax question, viewing events, viewing a tax blog, and/or viewing tax polls. In addition, the first header may comprise a navigation drop-down labeled “Welcome [Name of Free User]”, which allows a user to select one or more user interfaces or search subjects, such as a tax connections interface, which allows a free member to view professionals with whom he or she has connected, a tax questions interface, which allows the free member to view questions which he or she has asked (including any provided answers), and/or an account settings interface, which allows the free member to view or modify his or her account and/or profile information. The second header may comprise the same hyperlinks as the first header, but may comprise a navigation drop-down labeled “Welcome [Name of Tax Professional]”, which provides different options that allow a professional member to access the additional functionality of the web application that is available to professional members. For instance, the navigation drop-down of the second header may provide a list of tools available to the professional member, such as links to user interfaces for viewing a profile of the professional member, editing a profile of the professional member, entering the professional member's tax boardroom, viewing tax connections, viewing tax questions asked, viewing tax questions answered, viewing and editing account settings, etc. The drop-down may also comprise a link to an inbox of a private messaging system provided by the web application.

In an embodiment, the header may further comprise a search bar that is interfaced with a search engine. The search bar may comprise an input (e.g., text box) for entering keywords and/or other criteria, and a drop-down menu (e.g., the navigation drop-down discussed above) for selecting a specific portion or type of data to be searched. For example, the drop-down menu may allow a user to elect to search stored tax questions, a directory of tax professionals, or both. This allows a user to search a specific part of the web application for better results. If the user selects tax questions, then the user may enter keywords into the textbox, and the search engine will utilize the entered keywords to retrieve stored questions (e.g., from or using a questions module, discussed elsewhere herein) that have been previously answered by a tax professional through the web application. If the user selects tax professionals, then the search engine will utilize the entered keywords or criteria to retrieve a list of one or more tax professional members (e.g., from or using a professionals search module, described elsewhere herein) whose user profiles 114 contain the keywords or match the criteria.

2. Footer

Each user interface may also comprise a footer, which provides links to various aspects of the web application, including, without limitation, an about us page (e.g., biographies of team members of the operator of the web application), a contact us page (e.g., a form for submitting questions, concerns, or comments to the operator of the web application), a Frequently Asked Questions (FAQ) page, a guidelines page (e.g., listing guidelines for posting content to the web application), media/press page (e.g., a form for journalists and media to submit questions to the operator of the web application), memberships page (e.g., information regarding the benefits of becoming a member), privacy policy page, site map, tax jobs page (e.g., listing employment opportunities), terms of use page, tutorials (e.g., basic instructions on how to utilize the web application), report inappropriate content page (e.g., allowing users to flag content as inappropriate), and/or additional user interfaces or items.

3. Feedback Button

Each user interface may also comprise a feedback button. For example, the feedback button may be consistently and conveniently placed along the middle left of every web page. When a user clicks on the feedback button, a pop-up feedback user interface may appear that includes text fields for the user to fill out. If a user has logged in to the web application, some of these text fields may be automatically pre-populated for the user based on the user's account and/or profile information. The feedback user interface may comprise text fields for inputting the user's name, email address, company, location, and comments, suggestions, or other feedback that the user wishes to submit.

4. Home Page

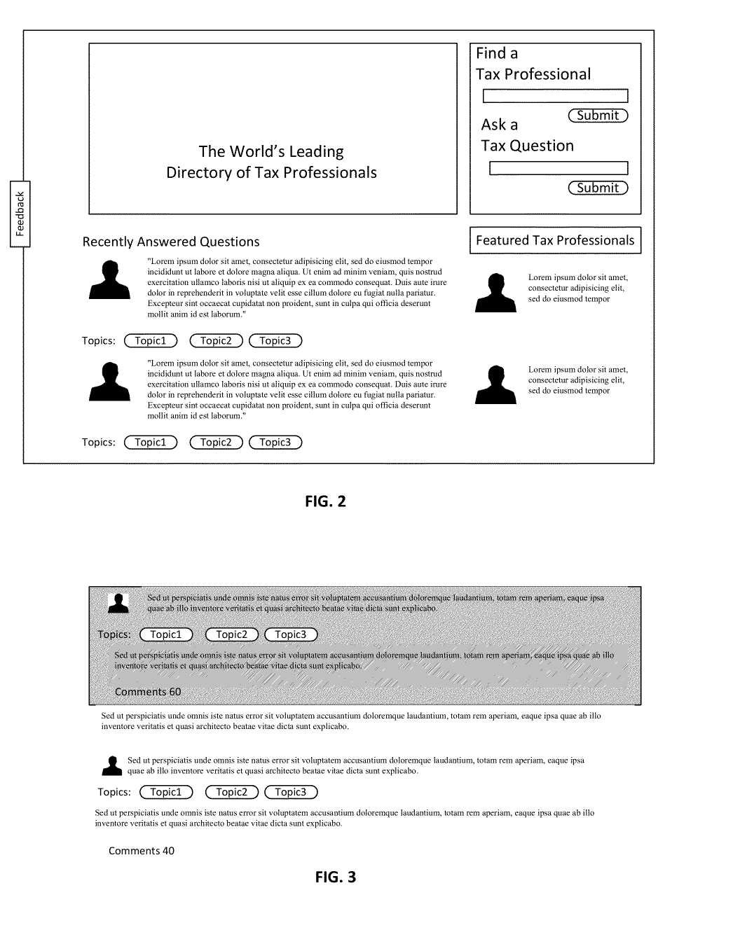

In an embodiment, the user interfaces of the web application comprise a home page. An example of such a home page is illustrated in FIG. 2. The purpose of the home page may be to communicate the web application's purpose of being an online directory resource and an interactive worldwide directory of tax professionals. The home page may also present users with all or some of the major options available to them while visiting the website. The home page may display photographs of numerous cities from around the world to provide a global feel to the web application.

In addition to the consistent header, footer, and/or feedback button, the home page may contain two search boxes: (a) a find-a-professional search box which interfaces with and provides inputs to a professionals search module, and (b) an ask-a-question search box which interfaces with and provides inputs to a questions module. The professionals search module provides a simple, intuitive interface for users to do a text-based search for a tax professional. The questions search module provides a simple, intuitive interface for users to locate questions and answers that are of interest to the user. Both search boxes may be prominently placed for quick and easy access.

The home page may comprise a recently-answered-questions panel, which lists the most recently answered questions between non-professional users and tax professionals. The recently-answered-questions panel may contain a predetermined number (e.g., four) of the most recently answered questions. These questions and answers can be streamed from a separate questions module of the web application. The recently-answered-questions panel on the home page may feature the tax question that was asked, information about the tax professional who answered the question, how long ago the question was answered, a tax topic or topics associated with the question (e.g., displayed as tags), and at least a portion of the answer to the question (e.g., the first sentence or line of the answer). The recently-answered-questions panel may also comprise an input (e.g., button) comprising a link to a user interface of the questions module for browsing all tax questions and answers.

The home page may also comprise a featured-professionals panel, which is an above-the-fold area for validated tax professionals. One or more algorithms may be used to determine how the featured-professionals panel is populated. The algorithm(s) may be driven by analytics collected by the web application. For example, the algorithm may select a predetermined number of the most recently validated tax professionals. The featured-professionals panel may list the selected tax professionals from most recent to least recent, and for each professional, include the tax professional's profile information and photograph, name, title, primary areas of tax expertise, current employer, and location (e.g., city and state). In an embodiment, users can click on either the name or the tax professional's profile picture to view the tax professional's complete profile page.

5. Professionals Search Module

In an embodiment, the web application comprises a professionals search module. This module may comprise a user interface or search page that can be accessed, for example, using the find-a-professional search box and/or a find-a-professional link in the header of one or more web pages of the web application. This professionals search user interface may comprise search results, which may comprise a list of tax professionals identified for a given query. The list of tax professionals may comprise basic information for each tax professional matching the given search criteria and filters, including, without limitation, a profile picture, name, title, current and/or recent employer, tax expertise, and/or current location (e.g., city and state). The user can click on one of the tax professionals in the list to be taken to the tax professional's profile page. Since the search page may only return a certain number of results per page (e.g., ten), at the bottom of the search results, there may be basic pagination buttons. A user can click a page number or “next” button to view other pages of the search results.

The professionals search user interface may comprise a search refinement feature. For example, the user interface may comprise a panel (e.g., on the left side of the interface) that filters a search based on various criteria. The panel may comprise content filters that a user may check (e.g., using checkbox inputs) to add a filter to the search. Examples of such filters include, without limitation, location, expertise, title, type of organization, industry, recent employer, languages spoken, etc.

In an embodiment, after an initial query, one or more filters presented to the user on the professionals search user interface may based on the search results that were brought back by the initial query. For example, there may be a filter for tax expertise that displays various tax expertise values relevant to the search results returned by the initial query. In other words, the tax expertise values may represent all of the fields of tax expertise possessed by the tax professionals returned in the search results. If a user then clicks a checkbox next to one or more of the tax expertise values, the search results may be dynamically and immediately refined so that only tax professionals matching the newly-selected tax expertise filter will be displayed. For example, if the user selects the checkbox next to a “Central America” tax expertise filter, the search results will be filtered to only those tax professionals who have listed “Central America” as one of their areas of tax expertise. As more tax professionals register with the web application, the list of possible filter criteria may grow or otherwise change to accommodate information collected about the registered tax professionals. Data that is received through the web application and the terms that are collected by various modules of the web application (e.g., professionals search module, questions module, events module, blog module, polls module, etc.) and other logistics of the web application can be used to determine and improve search algorithms.

In an embodiment, free members can search for professional members that match certain user-specified criteria, such as a geographic location, area of expertise, language, years of experience, and/or any other criteria that may be relevant or useful. Professional members can be selected and/or filtered by a search engine according to various algorithms that take into account one or more of the professional member's user profile information, demographics, areas of focus, experience, etc. The professional members can also be selected and/or filtered based on data related to the searching user, such as the searching user's demographics, needs, location, user profile information, questions, etc. In addition, the professional members can be selected and/or filtered based on other information, such as the types of answers the professional members have given to one or more questions posed using the web application, the frequency of answers that the professional members have given, peer ratings of the professional members (e.g., representing feedback to a professional's answer to a question, etc.), client ratings of the professional members (e.g., representing feedback to a professional's answer to a question, feedback about a professional's service of a client, etc.), and/or other activities on the web application (e.g., number or frequency of answers provided by the professional, ratings, etc.). As an illustrative, non-limiting example, if a particular professional member is located in California, speaks Japanese, and often works with small business owners, then when a small business owner of Japanese descent, living on the West Coast searches for a professional member, the search engine may identify the particular professional and present him or her as an option to the small business owner. Moreover, if the professional member often responds to questions from or relating to small business owners through the web application, and those answers are highly rated (e.g., based on feedback from other users), then the filter would be more likely to identify the particular professional member in the small business owner's search.

In an embodiment, the search engine may also be driven by algorithms that are run on data recorded over time. In other words, over time, an application on server platform 110 may generate and store data related to matches between users and professionals. This data may also comprise feedback about the satisfaction of both parties to the match. As this data grows, pattern recognition and other algorithms can be used to determine what drives compatible matches, and these determinations can be used by the search engine to improve search results. For example, the search engine can utilize this analysis of historical data to weight certain criteria, such as questions asked, location, profile information, and/or other search criteria, when responding to search requests.

5. Questions Module

In an embodiment, the web application comprises a questions module. This module may comprise one or more user interfaces via which a user can get information and advice on any number of tax questions they might have (e.g., from income tax to banking laws to international regulations and tax legislation). In one embodiment, the question module may comprise three main user interfaces: (a) a search interface for searching for tax questions and answers, (b) a discussion interface for reading, discussing, and clarifying more about a particular tax question or answer, and (c) a question interface for submitting a tax question to the worldwide tax community.

The search interface may comprise a search results panel which lists one or more tax questions that have been submitted, and a search panel providing inputs for searching available tax questions. In the search panel, one or more inputs may be provided which allow a user to enter keywords to search for tax questions (e.g., that other users have previously asked), or further refine already-found search results through one or more filters. For example, the search interface may comprise location, status, and topic filters. The location filter refines search results based on what country the tax question was asked about. The status filter allows users to choose to limit the search results to only those questions which have been answered or only those questions which have not been answered. The topic filter allows users to limit the search results to a particular topic. In an embodiment, tax topics are crowd-sourced tags that specify what areas a particular tax question belongs in. Thus, the list of topics may grow as more questions are submitted using the questions module. The filter criteria that are selected by the user determine what tax questions are displayed in the search result panel of the search interface.

In an embodiment, the search results panel of the search interface lists each question returned in the search results in a box. The box may contain the tax question as well as some additional information, including whether or not the question has been answered, by whom the question was answered, a brief snippet of the answer (if answered), and the topics that have been associated with the question (i.e., with which the question has been tagged). An example of the search results panel is shown in FIG. 3. A user may be able to view a pop-up of which tax professional(s) answered a particular question, as well as click on the question itself (or a “comments” link associated with the question) to view the question and all associated answers, comments, and/or clarifications. If a question remains unanswered and the user viewing the question is a tax professional member, a link may direct the user to answer the question or, if the user is not logged in, direct the user to a registration or login page.

In an embodiment, answers can be ranked and rated according to their usefulness. Users and tax professionals may be given the ability to rate how well a question was answered. Answers from tax professional members can be weighted higher than answers by a free member. In addition, users may be given the ability to flag questions and/or answers that are inappropriate in any way. If enough users flag a question and/or answer, it may be removed.

One or more user interfaces of the questions module may also comprise a leading-professionals panel, which may list one or more leading or featured tax professional members, as determined by an algorithm and/or predefined criteria. For instance, the leading tax professional members may comprise those tax professionals who have answered the most tax questions. The ratings of the members' answers may also be considered in determining which members should be listed in this panel. In an embodiment, the listing of the professional members may include, for each member, a profile picture, name, title, expertise, location (e.g., city, state, country), etc.

In an embodiment, if a user clicks on a tax question (e.g., in the search results panel), the user is directed to a question-details user interface comprising all of the information associated with a particular question. An example of the question-details user interface is illustrated in FIG. 4. This user interface may retain the search panel and the leading-professionals panel, and have a primary panel devoted to the selected tax question. A question portion (e.g., top portion) of this primary panel may comprise the question itself along with any description that the asker included with the question. The topics associated with the question may also be listed, along with how many times the tax question was asked, and when and from where the tax question was asked. If the asker has provided any question or any answers have requested clarification about the question itself, that information may be included with the question portion of the panel.

In an embodiment, immediately below the question portion of the primary panel of the question-details interface may be a button prompting the user to answer the question if they are a tax professional and can answer the question. If the user clicks the button but is not logged in, they may be redirected to a login page. If they are logged in as a free member, they may be redirected to a tax professional sign-up page. If they are logged in as a tax professional, a form field and button may appear for them to provide an answer. However, in an embodiment, if they have already answered the question, they are not allowed to leave another answer.

In an embodiment, below the question portion and the answer section of the primary panel of the question-details interface is a listing of all answers that have been submitted for the selected question, as well as any comments on those answers. This listing may take a consistent form, e.g., the answerer's profile picture and name followed by the answer they submitted. If the user is logged in and has answered the question, they may be given the option of editing or deleting his or her answer. Other tax professional members may have the option to leave a comment on an answer, flag an answer as inappropriate, or mark an answer as “useful” to help the system determine what the “best” answer is (e.g., using one or more algorithms).

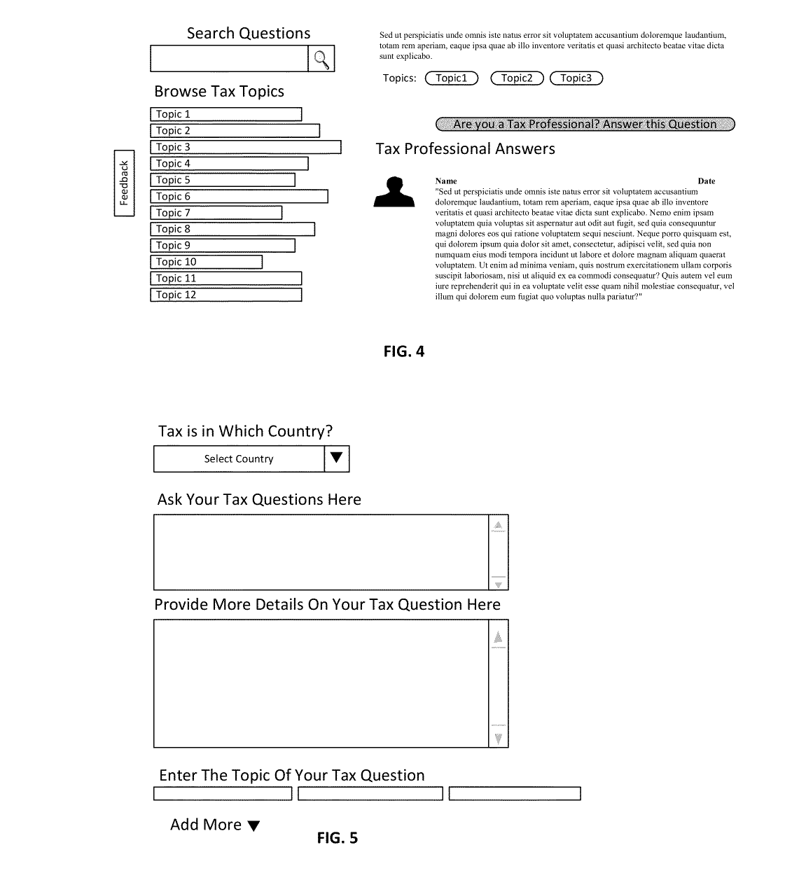

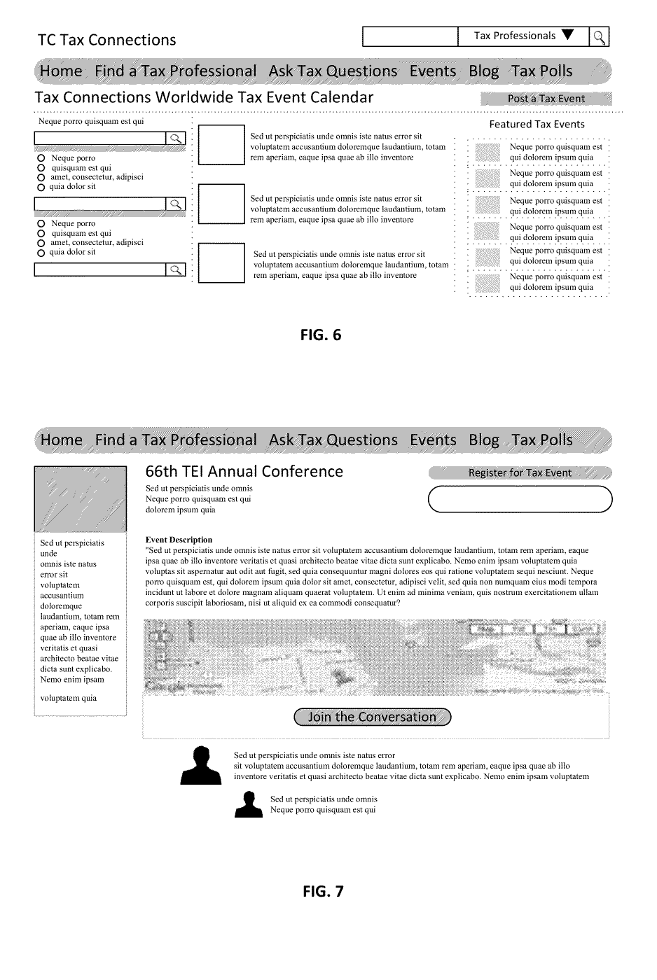

The questions module may also comprise a user interface for asking a new tax question. An input (e.g., link or button) may be visible in the header of every user interface provided by the questions module, which leads to an ask-question interface for submitting a question (if logged in) or a login interface (if not logged in). An example ask-question interface is illustrated in FIG. 5. The interface may comprise a form, comprising inputs into which the user may enter the country and state or province of their location, the question itself (which may be limited to a predefined number of characters with a dynamic display of remaining characters), and/or further details to help potential answerers of the question. The ask-questions interface may also comprise inputs into which the user may enter, or via which the user may select, one or more topics (e.g., at least one and up to six) to be associated with the question. These topics may be selected from a list of crowd-sourced topics via a pop-up window. In addition, the user may click a checkbox to agree to a Terms of Use agreement, privacy policy, and/or forum guidelines (which may all be conveniently linked), and then submit the tax question to be answered by the interactive worldwide directory of tax professionals supported by the web application.

6. Events Module

In an embodiment, the web application comprises an events module. The events module may provide an events calendar that allows all tax professionals and associations worldwide to list their events, conferences, seminars, webinars, and any continuing education training and social gatherings for tax professionals in one online resource directory. Every tax association currently faces the challenge of effectively marketing their offered conferences and continuing education classes to tax professionals. In addition, every tax professional currently faces the challenge of having to search through many different tax association websites to locate the right tax training course required for their continuing education requirements. By providing a single online directory for all tax events, tax professionals who are visiting a city (e.g., for business or personal reasons) can immediately know what tax courses are available to them in that city. Also, the events calendar may create better cross-training between tax professionals in each participating country. The events calendar can also be used as a major sales and marketing tool to attract tax professionals to the web application.

In an embodiment, the events module may comprise a searchable (e.g., by location, topic, etc.) events user interface that displays a list or grid of tax events (e.g., meeting the one or more search criteria). For example, the interface may comprise a list of five to ten tax events displayed in time-descending order. At the bottom of the interface, there may be a button that indicates “More Tax Events.” If the user clicks on the button, he or she may be shown a list of all tax events in the location for which the user is searching. In addition, the events user interface may comprise a search panel with a search box which receives keywords and one or more filter criteria for refining a search, e.g., by location, organization, event type, date, etc. For instance, the search panel may allow a user to select a date range that will display only those events that are within the specified date range. A drop-down calendar may also be provided for selecting the month, day, and year. Results based on date may include dates within a day or two of the selected date or date range.

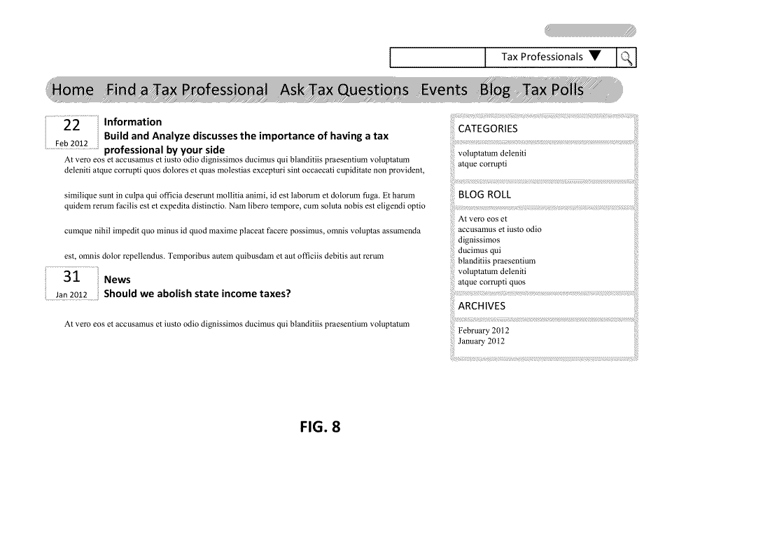

FIG. 6 illustrates an example of the events user interface, according to an embodiment. Each tax event may be listed with the name of the tax event, location of the tax event, date of the tax event, a brief summary of the tax event, and/or a logo uploaded by the organization (e.g., tax association) sponsoring the tax event. If a user selects a tax event (e.g., by clicking on the name of the event or the tax association logo associated with the event), the user may be shown an event-details user interface that provides the user with all of the information about the selected event.

In an embodiment, an organization (e.g., tax association) may pay to be a “Featured Tax Event.” Featured tax events may be displayed in a sponsored panel of one or more of the user interfaces provided by the event module (e.g., the events user interface).

In an embodiment, the events module may also provide an archive of tax events. This can be used for search engine optimization (SEO). One or more user interfaces of the events module may comprise a reference (e.g., hyperlink) to a tax events archive user interface, which will comprise all past events within a set or specified time frame. Inputs (e.g., a drop-down for day/month/year with a mini-calendar pop-out, when the drop-down is clicked, for selecting a date) may be provided to change the time frame (e.g., a start date and end date). The tax events archive user interface can be formatted the same way as the events user interface, but will display events from previous months or years with a feature that states “Previous Events.” All of the events may populate by month and year. In addition, all events may automatically change to events that happened in the selected month and year in a click-ordered chronology, and all of the months and years may drop down, giving the user the ability to select any month and year.

In an embodiment, the events module comprises a post-an-event user interface for posting a tax event to the events module. According to an embodiment, only professional members may post a tax event. A pop-up may be provided that states that you must be a tax professional to list any events. If a user is logged in as a professional member, then he or she may post a tax event by filling out inputs in the post-an-event user interface with event information (e.g., location, date, topics, etc.). This information will be used to generate an event-details user interface for the posted event, which may be viewed by other users.

A user who has submitted a tax event may be granted access to a landing page for the tax event. The landing page may be a user interface for all events posted by the user, and allows the user to manage communications with tax professionals who have registered for the event or otherwise indicated that they will attend the event. The events landing page may also comprise tools that allow the user to edit or delete event information. Other user interfaces provided by the web application to the user may provide a link (e.g., as a selection in a navigation drop-down of a header) to this events landing page, as well as a link to the post-an-event user interface.

FIG. 7 illustrates an example of the event-details user interface, according to an embodiment. The event-details user interface provides details regarding a selected event. For example, the event-details user interface may comprise all of the information entered for the event using the post-an-event user interface. In addition, the event-details user interface may comprise one or more of the following:

(a) A link (e.g., hyperlink containing a Uniform Resource Locator (URL) to an external or internal resource) for registering for the event. The link may be to an external website (e.g., of the organization that is sponsoring the event).

(b) One or more inputs for inviting one or more other users to the event. For instance, the input may comprise a text box for entering one or more email addresses, to which the web application will send an invitation. In an embodiment, the inputs may also allow the user to send an invitation to everyone in his or her tax community (e.g., all professional contacts through the web application).

(c) One or more inputs (e.g., a button marked “I Will Be Attending”) for RSVP'ing to the event, if the user is logged in as a professional member.

(d) An attendance list or link to an attendance list, which allows a user to see who is attending the event.

(e) Map and/or directions to the event. For example, the event-details user interface may interface with Google Maps™ to provide an indication of the location of the event overlaid on a virtual map of the area surrounding the event location.

(f) Comment section for discussing the tax event. The comments section may be similar in structure to the question-details user interface, described elsewhere herein.

In an embodiment, when a user (e.g., professional member) posts a tax event through the web application, a confirmation email may be sent to the user to confirm that the event was submitted. In addition, an email or alert may be sent to the user who submitted the event whenever a professional member confirms his or her attendance, and/or whenever someone has submitted a comment about the event. The events module may also perform analytics on how many users viewed the event, how many users registered for the event, how many users commented on the event, etc., and supply those analytics in an email or other interface to the user who submitted the event. In an embodiment, the events module may also send emails or alerts to tax professional members concerning tax events that have been submitted, based on geographical location, tax topics involved, tax organization sponsoring the event, type of event, etc.

7. Blog Module

In an embodiment, the web application comprises a blog module. The blog module may comprise one or more user interfaces, such as a blog-list user interface, and a blog-details user interface.

The blog-list user interface lists one or more blog entries. For instance, the blog-list user interface may comprise a standard two-column layout, with posted blog entries listed in one column (e.g., with the most recent entry on top) and with blog navigation and/or search features (e.g., category filters, links to archives, etc.) in the other column. It should be understood that the listed blog entries may actually only comprise a portion or preview of the blog entry, and may be displayed with other relevant information (e.g., name of user who posted the blog entry, time that the blog entry was posted, topic tags, etc.). FIG. 8 illustrates an example blog-list user interface, according to an embodiment.

In an embodiment, the blog-lists user interface may be a mash-up which aggregates blog entries from multiple external sources. Alternatively or additionally, the blog-lists user interface may list blog entries which are hosted by the web application. For instance, the web application may provide one or more user interfaces which allow users (e.g., professional members) to maintain and manage their own tax blogs. For instance, a blog dashboard may be provided by the web application. The blog dashboard may be linked to through the navigation drop-down in the header provided to professional members. In an embodiment, the blog dashboard allows a professional member to establish a blog category, input or edit a blogroll (e.g., a list of other blogs that the blogger recommends), preview, post, edit, and publish a blog entry, and view prior blog entry posts and/or archives. The blog dashboard may also display analytics about the professional member's blog, such a the number of views, how long users are viewing blog entries, the city, state, and country of readers of the blog entries, etc.

In addition, professional members who have established a blog may be given a tax blogger tag on their user profile interfaces, which may be visible and searchable by other users. Professional members who are bloggers may also be provided a link (e.g., hyperlink) on their user profile interface, which directs users to a list of their blog entries.

The blog-list user interface may be searchable. For example, the interface may comprise a search panel with one or more inputs via which a user can search blog entries by keyword, topic, location, etc. In this manner, a user may be able to refine the search by keyword on any topic of interest written about by a tax blogger. Users may also be able to refine the search by country or other location. This can be advantageous since tax rules and regulations generally differ among countries.

If a user clicks on a blog entry listed in the blog-list user interface, the user may be directed to a blog-details user interface for the selected blog entry. The blog details user interface provides the entire blog entry, along with relevant information, such as the name of the user who posted the blog, time that the blog entry was posted, topic tags, etc. The blog-details user interface may also provide one or more inputs for users to input comments on the blog entry. In addition, if the user is a blog administrator (e.g., the user who posted the blog entry), the blog-details user interface may also comprise one or more inputs for editing the blog entry.

The blog module or other module of the web application may analyze the blogs of users to determine the top tax bloggers. In an embodiment, top tax bloggers may be determined to be those bloggers who have been voted as the best by users of the web application. Blogs can be ranked by the number of views of their content and/or other feedback from readers. Top tax bloggers may be provided a badge (e.g., icon) or other indication that can be prominently displayed on the professional member's profile interface and viewed by users.

8. Polls Module

In an embodiment, the web application comprises a polls module, which allows polls or surveys of users to be taken. Tax polls provide a simple, interactive solution for allowing users to express their opinions on subjective tax matters. For example, the polls module may receive and display a question on one or more user interfaces of the web application (e.g., the home page, as a question on a user interface of the questions module, etc.). Users can read the question, select an answer from a list of options (e.g., by selecting one or more of a plurality of radio buttons or checkboxes), and click a voting input (e.g., button) to record their votes. Each vote may be recorded in association with an Internet Protocol (IP) address and only one vote may be allowed per IP address in order to prevent users from voting more than once for a particular tax poll. Once a user votes, the list of options may be replaced with a bar graph that displays a bar for each option that represents the number of users who have voted for that option. In an embodiment, an input (e.g., hyperlink) may be provided which allows users to view results for past tax polls, as well as a list of recent tax polls, the date and/or time they were posted, and/or how many views they received.

9. Registration Module

In an embodiment, the web application comprises a registration module for registering users with the web application. Specifically, the registration module allows visitors to register with the web application to become a member by creating a user account 112 and/or user profile 114. The visitor may register as a free member or a professional member. For instance, the web application may comprise a sign up user interface that provides one or more inputs for selecting either a free member account or a professional member account. The free member account may be free of charge, whereas the professional member account may require a subscription fee, such as a monthly subscription fee. The user account 112 and/or user profile 114 may comprise different data depending on whether the member is registered as a professional or free member.

Once registered, a member may log in to server platform 110 to access the functionality of the web application. For example, a free member seeking a professional may log in to his or her user account 112, using a username and password supplied during registration, and interact with registered professionals, review information, post questions, and the like. A free member may interact with a professional member by asking questions. In an embodiment, the web application may comprise a public message board, through which a free member can post a question and any professional member can post a response. Professional members can also be allowed to post questions, information, answers to hypotheticals, and the like.

In an embodiment, the registration module may comprise a first set of one or more user interfaces, which allow a user to provide basic sign-up information, such as a username and password. This set of user interfaces may identical or similar for professional and non-professional members. In addition, during registration of a non-professional and/or professional member, the registration module may also require the user to validate their newly acquired account access.

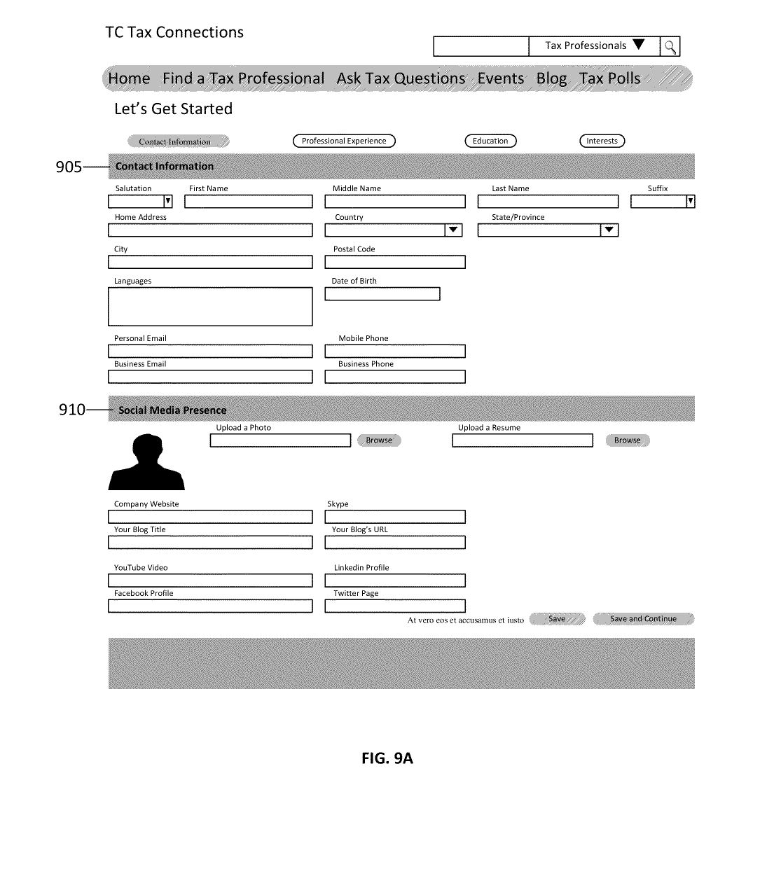

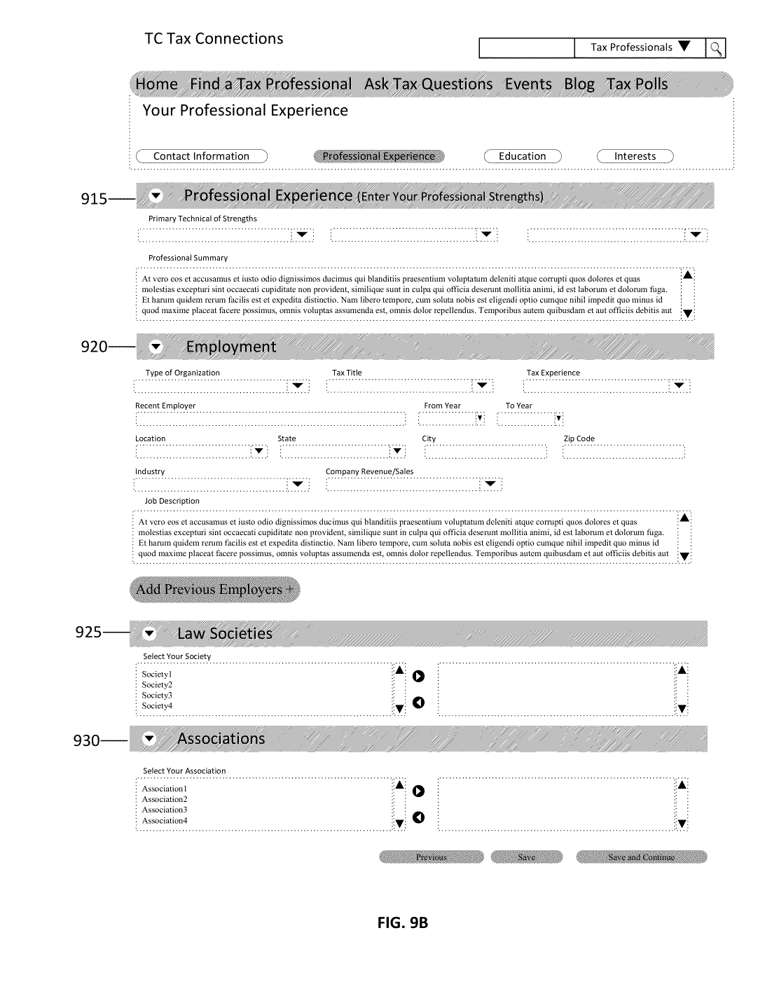

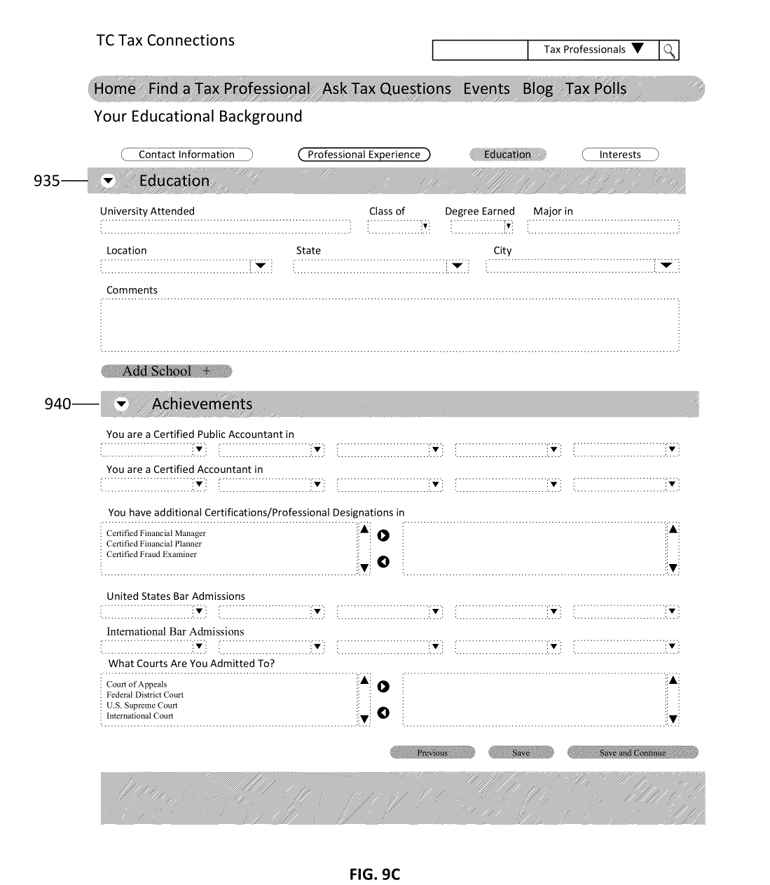

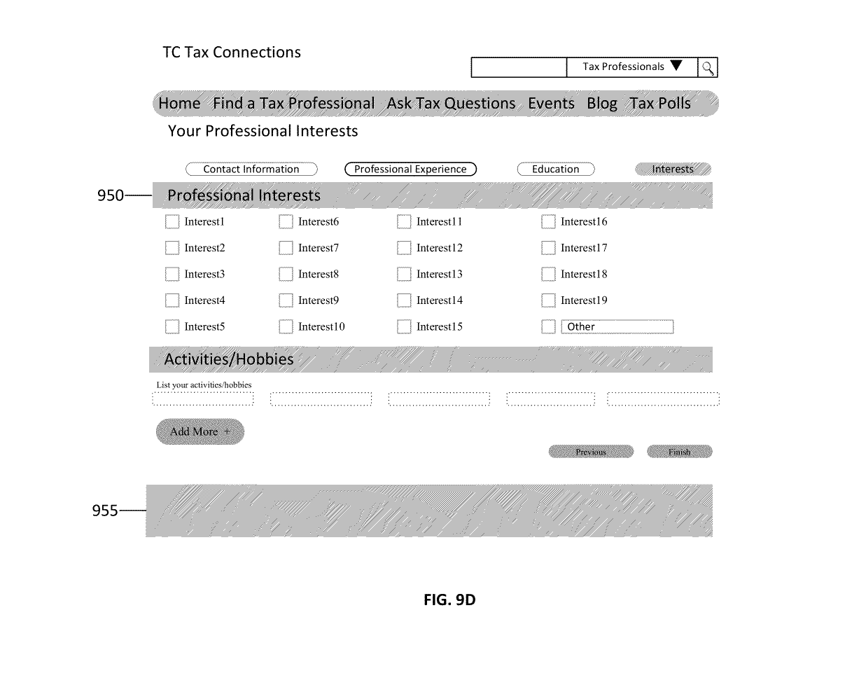

However, when registration is of a professional member, the registration module may provide an additional or different set of one or more user interfaces than during registration of a non-professional member. This set of user interfaces may comprise one or more sections. Examples of user interfaces that may be used for registration of a tax professional will now be discussed with reference to FIGS. 9A-9D. In this illustrated example, the set of user interfaces is divided into ten sections: contact information, social media presence, professional experience, employment, law societies, associations, education, achievements, professional interests, and activities/hobbies. Professional users may be instructed to fill out the form as thoroughly as they can, as the supplied information will be used to populate their user profile. As the professional user goes through the section, entering information, they may be given the options to save the inputted information, save the inputted information and continue inputting information, and after completion of the first section, to return to a previous section.

As illustrated in FIG. 9A, contact-information section 905 may comprise inputs which allow a professional user to input basic contact information. The contact information may include, without limitation, a salutation, first name, middle name, last name, last name suffix, home address, country, state/province, city, postal code, language(s) spoken (e.g., using a drop-down or text selection area), date of birth, personal email, mobile phone number, business email, and/or business phone number.

As illustrated in FIG. 9A, social-media-presence section 910 may comprise inputs which allow a professional user to upload a photograph, résumé, and share his or her social sites. For example, a file selection input (e.g., “browse” button) may be provided for uploading a photograph, and another file selection input may be provided for uploading a résumé (e.g., as a Microsoft Word™ document or in Portable Document Format (PDF)). social-media-presence section 910 may also comprise text boxes for entering a company website address, Skype™ user identifier, blog title, blog URL, YouTube™ video, LinkedIn™ profile URL, Facebook™ profile URL, and/or Twitter™ page URL.

As illustrated in FIG. 9B, professional-experience section 915 may comprise inputs which allow a professional user to provide his or her primary area(s) of technical strength/expertise. For instance, drop-down menus may be provided, which allow the user to select one or more (e.g., three) areas of primary technical strength from a plurality of available areas. In addition, professional-experience section 915 may comprise a text box or text area into which a professional user may enter a professional summary. Each tax professional may be encouraged to spend time filling out this area properly in order to promote his or her tax expertise to the widest audience available.

As illustrated in FIG. 9B, employment section 920 may comprise inputs which allow a professional user to enter his or her recent employment. In addition, an input may be provided which allows a professional user to add additional employment sections to enter additional employment information. In an embodiment, the number of additional employment information may be limited for security. For example, a professional user may be allowed to add as many as fifteen previous employers. Each employment section comprises inputs (e.g., text box, text area, etc.) for a user to enter and/or select a type of organization, tax title, tax expertise, recent employer name, year that employment at the employer began, year that the employment at the employer ended, location (e.g., country, state, city, postal code), industry, company revenues/sales, and/or a job description.

As illustrated in FIG. 9B, law-societies section 925 may comprise inputs which allow a professional user to input one or more law societies of which he or she may be a member. Law-societies section 925 may be geared towards users in countries outside the United States, and may comprise two side-by-side list menus. A user may select a law society or societies from the list on the left side, and click an input (e.g., right arrow icon) to add the selected law society or societies to the list on the right side. Conversely, a user may select a law society or societies from the list on the right side, and click an input (e.g., left arrow icon) to remove the selected law society or societies from the list on the right side. The law societies in the list on the right side will be associated with the user when he or she saves the inputted information.

As illustrated in FIG. 9B, associations section 930 may comprise inputs which allow a professional user to input one or more associations of which he or she may be a member. Associations section 930 may be similar or identical to law-societies section 925 in format, except that instead of the user moving law societies from one list menu to another list menu, he or she may move associations from one list menu (e.g., a left side list menu) to a second list menu (e.g., a right side list menu), and vice versa.

As illustrated in FIG. 9C, education section 935 may comprise inputs which allow a professional user to enter educational details (e.g., university attended). In addition, an input may be provided which allows a professional user to add additional educational sections to enter additional educational information. In an embodiment, the number of additional educational information may be limited (e.g., up to fifteen additional universities). Each educational section comprises inputs (e.g., text box, text area, drop-down menus, etc.) for a user to enter and/or select the name of a university, class year, type of degree earned, major, location (e.g., country, state, city), and/or comments.

As illustrated in FIG. 9C, achievements section 940 may comprise inputs which allow a professional user to input or select certifications and achievements. In an embodiment, achievements section 940 comprises multiple sub-sections for each of a variety of possible types of certification or achievement. For example, sub-sections may be provided for entering one or more area (e.g., states, provinces, countries, etc.) in which the user is a certified public account, one or more areas in which the user is a chartered accountant, one or more areas in which the user has bar admission, and one or more areas in which the user has international bar admission. Each sub-section may provide five drop-down menus for selecting five different areas in which the user is licensed, admitted, etc. In addition, an input may be provided which allows a user to add additional drop-down menus for additional area selections (e.g., up to fifteen total areas per sub-section). Achievements section 940 may also comprise a sub-section which allows a professional user to select additional certifications and/or professional designations, and a sub-section which allows a professional user to select courts to which he or she is admitted. These sub-sections may comprise the same dual menu list format as described above with respect to law-societies section 925, which allows a user to move selections from a first list (e.g., left list) to a second list (e.g., right list), and/or vice versa, using one or more inputs (e.g., arrow icons). Those selections in the second list will be associated with the professional user when he or she saves the inputted information. Examples of additional certifications or professional designations include, without limitation, certified financial manager, certified financial planner, certified fraud examiner, certified fund specialist, etc.

As illustrated in FIG. 9D, professional-interests section 950 may comprise inputs which allow a professional user to select one or more areas about which they would like to receive alerts. For example, professional-interests section 950 may comprise a plurality of checkboxes, with each checkbox associated with one of a plurality of professional interests. A user may select the checkbox for each professional interest about which he or she wants to receive alerts, notifications, or other information from the web application. There may also be inputs for entering and selecting one or more other professional interests. Examples of professional interests include, without limitation, building tax professional brand, business development, contract/consulting projects, tax internships, building tax network, tax communities, tax professional connections, conference speaker, tax events, tax webinars, search services, tax blogger/writer, tax expert panelist, tax salary surveys, job opportunities, tax professor/instructor, generating new clients, mergers and acquisitions tax practice, and/or technical tax help.

As illustrated in FIG. 9D, activities/hobbies section 955 may comprise inputs which allow a professional user to input or discuss his or personal interests. These interests may be displayed on the professional user's tax boardroom interface. For example, activities/hobbies section 955 may comprise five text box inputs, which may be expanded up to fifteen text box inputs.

Once a professional user has finished with all of the sections (e.g., 905-955), he or she may click on an input (e.g., “finish” button) which completes the registration process.

10. Profile Module

In an embodiment, the web application comprises a profile module. The profile module generates one or more profile user interfaces for each professional member. The profile user interface can be viewed by other users, for example, when other users click on the professional member's name and/or photograph wherever they may appear on any of the web pages of the web application. A professional member's profile user interface displays information about the professional member, so that users can view the overall tax knowledge and expertise of the tax professional member. All of the information displayed on the profile user interface may come from the registration module.

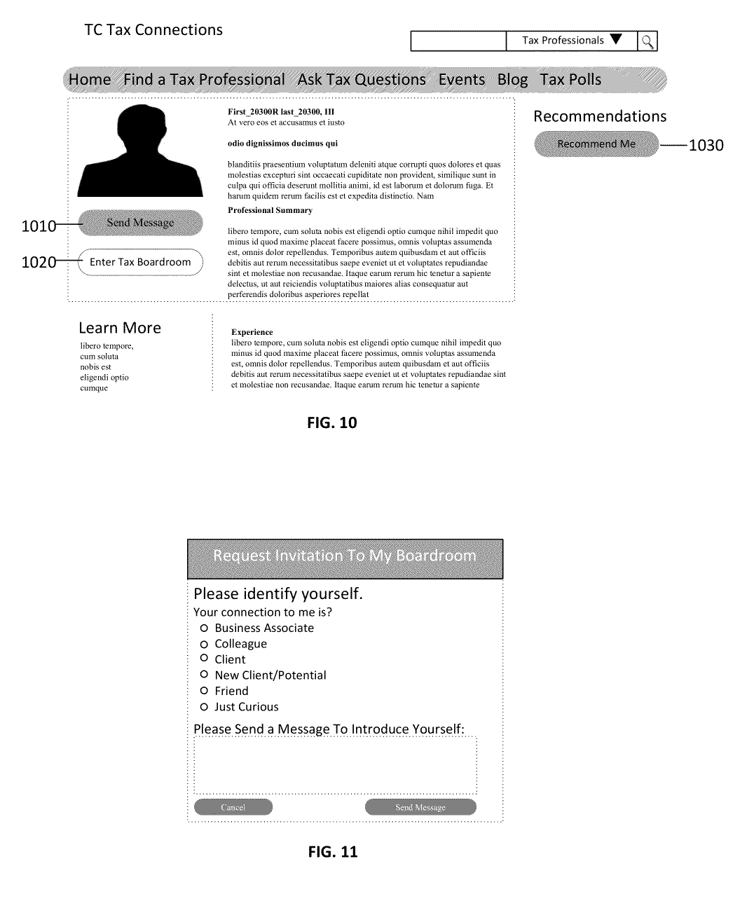

FIG. 10 illustrates an example of a profile user interface, according to an embodiment. In an embodiment, the profile user interface may comprise a “send message” input 1010 (e.g., button) which allows a user to send a message directly to the professional member associated with the profile user interface. If a user clicks on “send message” input 1010, the web application may display a pop-up which allows the user to send a message to the tax professional member via the web application's messaging system. If the user is not logged in, the user may be routed to the login page before being able to send a message.

The profile user interface may also comprise a “tax boardroom” input 1020 (e.g., button) which allows a user to go to the professional member's tax boardroom. If a user clicks on “tax boardroom” input 1020, the user may be directed to the tax professional member's tax boardroom, which is described elsewhere herein.

The profile user interface may also comprise a “recommend” input 1030 (e.g., button) which allows a user to recommend a tax professional. If a user clicks on “recommend” input 1030, the web application may display a pop-up which allows the user to send a message to another user via the web application's messaging system. If the user is not logged in, the user may be routed to the login page before being able to send a message. The pop-up may comprise inputs which allow the user to enter and/or select the user's name, company, and text comprising the user's recommendation (e.g., a testimonial about the professional member). The pop-up may also provide the user an option to inform the professional member about the user's recommendation via a message.

11. Tax Boardroom Module

In an embodiment, the web application provides each professional member with a virtual tax boardroom. As mentioned elsewhere herein, a professional member's profile user interface may comprise an input for interacting with the professional member in his or her private tax boardroom. In addition, such an input may be provided for each of a plurality of professional members who appear in a user's search results.

If a user clicks “tax boardroom” input 1020 and is logged in, the user may be directed to a tax-boardroom-request user interface (e.g., which may comprise a pop-up). If the user is not logged in, the user may be directed to the login page. FIG. 11 illustrates an example of the tax-boardroom-request user interface, according to an embodiment. Using the tax-boardroom-request user interface, a user may request entry to the professional member's tax boardroom by entering identification information and/or a message. For example, the tax-boardroom-request user interface may comprise inputs for a user to identify his or her connection to the professional member (e.g., business associate, colleague, client, new potential client, friend, just curious, etc.) and a message introducing himself or herself This information allows the professional member to screen user who wish to participate in his or her tax boardroom.

Once a user submits his or her request using the tax-boardroom-request user interface, a message or other notice may be sent to the corresponding professional member (e.g., sent to the professional member's inbox). The notice may comprise an input through which the professional member may approve the connection and allow the user to enter the professional member's associated tax boardroom.

Forcing users to request access to a professional member's tax boardroom prior to being granted access allows a tax professional member to screen out anyone that they do not want into his or her private area, including advertisers, recruiters, human resources, or anyone else whom they feel may waste his or her time. Conventionally, screening presents one of the biggest time-wasting activities for tax professionals. The web application may provide well-written template letters that a professional member can utilize to screen out anyone that they cannot or do not wish to help.

The virtual tax boardroom allows a professional member to communicate more privately about tax issues. For instance, there may be some tax issues which users may not want posted in the open (e.g., using the questions module). The boardroom is a private or semi-private user interface that allows the seeking user to communicate in a one-on-one setting with a professional member. The virtual boardroom may allow the seeking user to continue to post messages for the professional and received responses to those messages, but in a private setting that is not viewable by other users. Alternatively or additionally, the virtual boardroom may comprise network-based video and/or audio conferencing. For instance, in an embodiment, the tax boardroom may comprise the ability to video chat (e.g., using a service such as Skype™) so that a user can talk face-to-face with a tax professional member (e.g., over an Internet connection). The web application may provide a dashboard for every professional member, which allows the professional member to manage and organize all of his or her private communications with other users.

12. Ratings Module

In an embodiment, the web application comprises a ratings module which can receive input or feedback about a professional. The web application may utilize this feedback to generate a rating for each professional. For example, the web application may be configured to run various algorithms on the feedback to rate the professionals. The generated ratings can be used to filter the professionals in response to a search request, as a search selection criterion, to evaluate the professional for continued membership with the web application, etc.

In an embodiment, the web application may comprise a ratings engine which receives input related to activity by a professional on the web application. Such input may comprise answers to questions, event postings, participation in discussions, etc., including the frequency and/or ratings of such activities. The input to the ratings engine may also include feedback from users who have engaged the professional member's services. The ratings engine may output a ranking for the professional that can be input to a search engine.

13. Messaging Module

In an embodiment, the web application comprises a messaging module. The messaging module may provide each member with an inbox, which comprises the main messaging center for professional members and non-professional members alike. The messaging module may comprise user interfaces similar to any standard email account with user interfaces for an inbox, a list of sent messages, and a list of deleted messages. The user interfaces of the messaging module may also comprise a “compose message” input (e.g., button) which brings up a pop-up or other user interface for a user to compose a message, including identifying to whom to send the message (e.g., by selecting from a drop-down or list menu of the user's connections/contacts), inputting a subject of the message, and inputting a body of the message.

In the inbox user interface, the user can view a message, reply, and/or move a message to a deleted messages folder. The inbox user interface may also comprise additional functionality, such a forwarding a message to another member, replying to all users associated with a message, and/or marking various messages as deleted, read, or unread.

In an embodiment, the messaging module implements thread-based messaging. What a member will see in his or her inbox is the latest correspondence in the thread and also the number of messages in the thread. When a user clicks the thread (e.g., in the inbox), the entire thread may be opened, so that the user can see the complete history of the discussion. If the user is outside of the thread, the history of the thread will be maintained. If the user is outside of the thread and clicks to compose a message, a new thread may be started.

14. Account Settings Module

In an embodiment, the web application comprises an account settings module. The account settings module comprises one or more user interfaces which allows a member to change basic information in his or her account. For example, the account settings module may comprise a first user interface which comprises inputs which allow a user to change his or her first name, last name, email address, etc. A second user interface may comprise inputs which allow a user to change his or her password.

If a user has connected to the web application through a third-party API (e.g., Facebook™, Twitter™, or LinkedIn™), the user interface for changing a password may not be accessible to the user, since changing the password could break their ability to login through the third-party service. Instead, the user interface for changing the password may be replaced with an informational message, providing instructions on how to change the user's password at the third-party service through which they logged in.

If a user is logged in as a basic member (e.g., free member), they may be presented with an option (e.g., as a button or other input on a user interface of the account settings module) to “upgrade” their membership from basic or free member to professional member. If a user chooses to upgrade their membership, the web application may redirect the user to a promotional code user interface and/or to a payment user interface, so that the user can complete the upgrade process and become a fully validated tax professional member. Once the upgrade process is complete, the web application changes the user's role (e.g., as stored in a database) to “professional.”

Example Processing Device

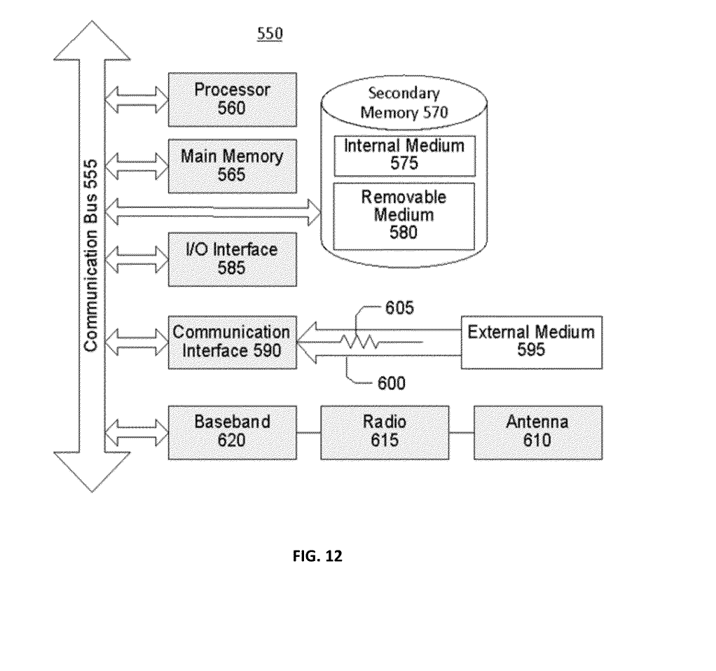

FIG. 12 is a block diagram illustrating an example wired or wireless system 550 that may be used in connection with various embodiments described herein. For example the system 550 may be used as or in conjunction with one or more of the mechanisms or processes described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Perl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such that the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for selecting a tax professional, the method comprising, by at least one hardware processor executing a web application:
receiving one or more search criteria from a user;
generating rating information associated with each of a plurality of professional users;
filtering the plurality of professional users, based on the one or more search criteria and the rating information, to identify a subset of one or more professional users; and
providing the identified subset of one or more professional users to the user.

2. The method of claim 1, further comprising receiving activity information about one or more interactions with the web application by a professional user, and generating the rating information for the professional user based on the received activity information.

3. The method of claim 2, further comprising applying weights to the activity information, and generating the rating information for the professional user based on the weighted activity information.

4. The method of claim 2, wherein the activity information comprises a frequency of the one or more interactions.

5. The method of claim 2, wherein the activity information comprises feedback from a user, other than the professional user, about the one or more interactions.

6. The method of claim 1, further comprising providing a set of one or more menus from which the user selects the one or more search criteria.

7. The method of claim 1, further comprising:
providing at least a first user interface to which users can post questions;
for each of the plurality of professional users, providing at least a second user interface comprising information about the professional user; and,
for each of the plurality of professional users, providing a virtual boardroom interface in which a user can interact with the professional user.

8. The method of claim 7, wherein the virtual boardroom interface comprises audio or video conferencing.

9. The method of claim 7, further comprising receiving a request from a user for an interaction with a professional user via the virtual boardroom interface of the professional user.

10. The method of claim 9, further comprising scheduling a time for the requested interaction.

11. A system for selecting a tax professional, the system comprising:
at least one hardware processor; and
at least one executable software module that, when executed by the at least one hardware processor,
receives one or more search criteria from a user,
generates rating information associated with each of a plurality of professional users,
filters the plurality of professional users, based on the one or more search criteria and the rating information, to identify a subset of one or more professional users, and
provides the identified subset of one or more professional users to the user.

12. The system of claim 11, wherein the at least one executable software module further receives activity information about one or more interactions with the web application by a professional user, and generates the rating information for the professional user based on the received activity information.

13. The system of claim 12, wherein the at least one executable software module further applies weights to the activity information, and generates the rating information for the professional user based on the weighted activity information.

14. The system of claim 12, wherein the activity information comprises a frequency of the one or more interactions.

15. The system of claim 12, wherein the activity information comprises feedback from a user, other than the professional user, about the one or more interactions.

16. The system of claim 11, wherein the at least one executable software module further provides a set of one or more menus from which the user selects the one or more search criteria.

17. The system of claim 11, wherein the at least one executable software module further:
provides at least a first user interface to which users can post questions;
for each of the plurality of professional users, provides at least a second user interface comprising information about the professional user; and,
for each of the plurality of professional users, provides a virtual boardroom interface in which a user can interact with the professional user.

18. The system of claim 17, wherein the virtual boardroom interface comprises audio or video conferencing.

19. The system of claim 17, wherein the at least one executable software module further receives a request from a user for an interaction with a professional user via the virtual boardroom interface of the professional user.

20. The system of claim 19, wherein the at least one executable software module further schedules a time for the requested interaction.
